(19) United States
(12) Patent Application Publication
(10) Pub. No.: US 2008/0197146 A1
(43) Pub. Date: Aug. 21, 2008

(54) Audio, visual, and/or data collection device for tap

(75) Inventor: Matthew J. Eyler, New Paltz, NY (US)

Correspondence Address: FOLEY AND LARDNER LLP;SUITE 500, 3000 K STREET NW, WASHINGTON, DC, 20007, US

(73) Assignee: EYLER GIZMOS, LLC

(21) Appl. No.: 12/068,823

(22) Filed: Feb. 12, 2008

Related U.S. Application Data
(60) Provisional application No. 60/890,915, filed on Feb. 21, 2007.
(60) Provisional application No. 60/910,603, filed on Apr. 6, 2007.

(51) Int. Cl. B67D 5/00

(52) U.S. Cl. 222/39; 222/40

(57) ABSTRACT

The device includes a housing, a detector configured to detect activation of the liquid dispensing assembly; and control circuitry configured to cause at least one of transmission of information and recording of data in response to detected activation of the liquid dispensing assembly. Upon activation of the liquid dispensing assembly, the device can transmit information and/or record and collect data. Preferably the transmitted information is an auditory advertising message.

### CROSS REFERENCE TO RELATED APPLICATIONS

This application claims priority from U.S. Provisional Patent Application Ser. No. 60/890,915, filed Feb. 21, 2007, and U.S. Provisional Patent Application Ser. No. 60/910,603, filed Apr. 6, 2007, both of which are hereby incorporated by reference herein in their entireties.

### BACKGROUND OF THE INVENTION

1. Field of the Invention

The invention relates to an audio, visual, and/or data collection device for a tap and, more particularly, to an audio, visual, and/or data collection device for a tap that is capable of delivering information in response to usage of the tap and/or recording and collecting data, such as the time, date, and duration of each activation of the tap.

2. Description of Related Art

In a tavern, beer is often dispensed by a bartender activating a conventional tap 10, i.e., moving the tap 10 from its standby position (as shown in FIG. 3) to a flow position (the position reached by the tap after moving in the direction of the arrow 12 in FIG. 3). Moving the tap to the flow position opens a valve, which allows beer to flow from a keg or other reservoir into a glass. As the glass becomes full, the bartender returns the tap 10 to its standby position to close the valve and stop the flow of beer.

A conventional tap 10 often includes a base 20 having a spigot 22, as shown in FIG. 3. A beer line 24 is connected to the base 20 such that beer can flow out of the spigot 22 when the tap 10 is activated. The tap 10 typically also includes a handle 30 connected to the base 20. The handle 30 often will have a threaded recess 32 that threads onto a threaded bolt 26 located at the top portion of the base 20. The handle 30 enhances leverage, which makes it easier to activate the base 20. Another important function of the handle 30 is to deliver information regarding the beer being dispensed. For example, the handle 30 will often include the name of the beer and graphics associated with that beer.

Conventional devices have been developed to deliver information to tavern patrons in response to the activation of a beer tap. Such devices, however, have suffered from a variety of drawbacks and limitations. For example, a conventional device includes a motion-activated translucent handle that displays flashing lights to draw attention to the brand on the handle. To install this device, the original handle is removed from the base and replaced by the device. Consequently, the device must be custom manufactured if it is to reflect the beer being poured. Additionally, the device is less than optimal in attracting the attention of the user, as it provides only visual information and not auditory information. Other conventional devices suffer different problems, such as requiring connection to an external power supply or to external devices, which can be problematic in the tavern environment. These devices also may be bulky, which again can be problematic in the tavern environment. While devices that record the number of pours of a tap exist, they are not self-contained, handle-integrated, or equipped to record the time, date, and duration of pours.

### BRIEF DESCRIPTION OF THE DRAWINGS

The accompanying drawings, which are incorporated in and constitute a part of this specification, illustrate embodiments of the invention and together with the description serve to explain principles of the invention.

FIG. 1 is a side, exploded view of a tap and a device for the tap according to the present invention.

FIG. 2 is a side, cross-sectional view of the tap and device of FIG. 1.

FIG. 3 is a side, cross-sectional view of a conventional tap.

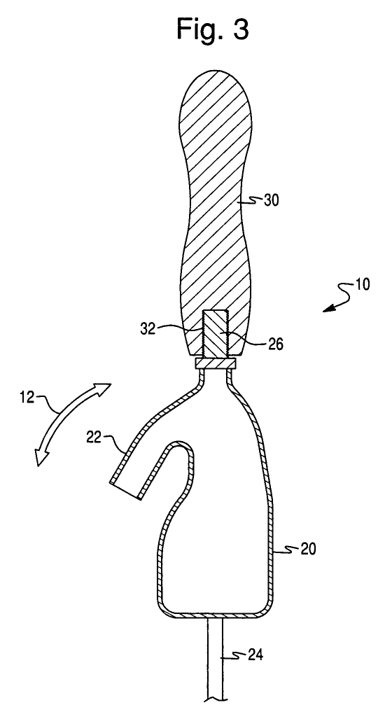

FIG. 4 is a schematic view of elements of an embodiment of the device of FIG. 1.

FIG. 5 is a schematic view of elements of another embodiment of the device of FIG. 1.

FIG. 6 is a side, cross-sectional view of another embodiment of a device according to the present invention, in which the device includes an affixed handle.

### DETAILED DESCRIPTION OF PREFERRED EMBODIMENTS

Presently preferred embodiments of the invention are illustrated in the drawings. An effort has been made to use the same or like reference numbers throughout the drawings to refer to the same or like parts.

The present invention relates to a device that can transmit and/or record information upon activation of a tap 10, i.e., when the base 20 of the tap 10 is moved to the flow position. Preferably the transmitted information is an auditory message (or messages) and the preferred recorded information is a stored record of the time, date, and duration of each pour. The tap 10 preferably is a tap for beer, though it could be a tap for other fluids. Preferably the device of the present invention can be inserted without modification between the base 20 and handle 30 of a conventional tap, such that the device will become an integral part of a standard beer tap assembly. In this manner, the device can be used to deliver advertising, public service, or other messages to patrons or others within the vicinity of the tap. Consequently, beer companies or other users can deliver audio and/or visual messages to customers at the point of sale in a cost-effective manner while continuing to use existing taps and decorative handles. In addition, the device can be configured to record detailed tap usage information that can be used by beer companies, advertisers, consultants, market research firms, or other users for consumption research, advertising research and placement, and/or promotional event planning purposes, for example.

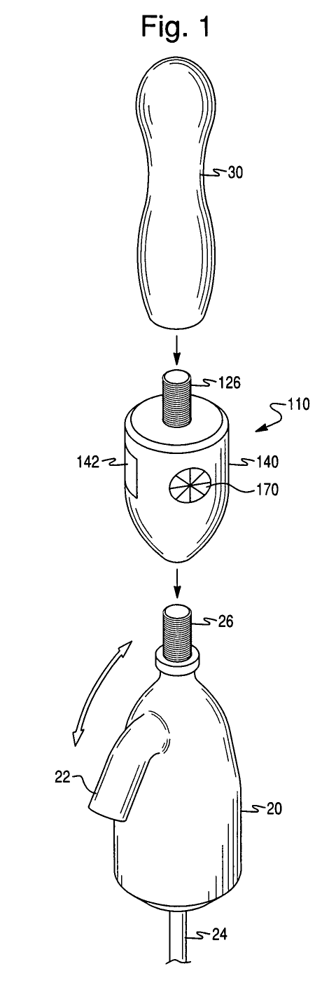

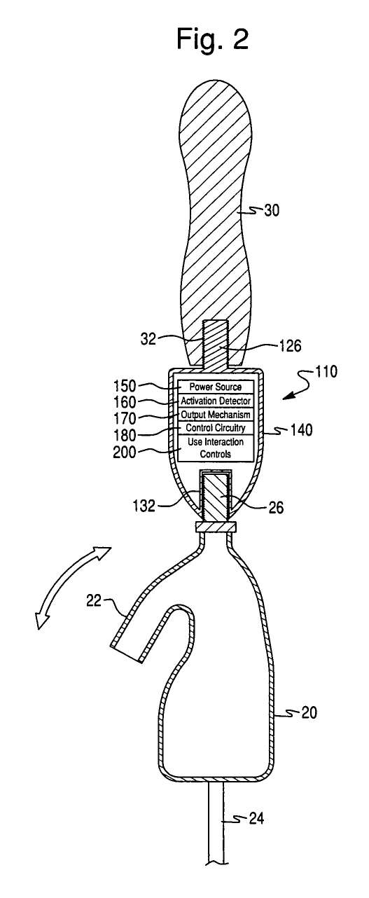

As shown in FIGS. 1 and 2, an embodiment of a device 110 according to the present invention preferably includes a housing 140, a power source 150, a tap activation detector 160, one or more output mechanisms 170, control circuitry 180, and user interaction controls 200. Certain of these features, such as the output mechanism 170, may be omitted if the device is performing only data collection.

The housing 140 is provided to house and contain the elements of the device 110 and to connect them to the conventional tap 10. The housing 140 preferably has a generally cylindrical shape measuring approximately two to four inches tall and two inches in diameter. The housing 140 should have sufficient structural integrity to withstand the physical stress placed upon it when the handle 30 is pulled down to the flow position and pushed up to the standby position. The housing 140 could be made, for example, of metal, plastic, or a combination thereof. Preferably the housing 140 is configured such that it is liquid-proof or at least liquid resistant, to allow it to protect the elements of the device 110.

The housing 140 preferably includes an easily-reached access door 142 (see FIG. 1) that gives the user access to internal elements, such as the power source 150 and/or the control circuitry 180. Preferably the access door 142 is configured to form a liquid-tight seal with the remainder of the housing 140. In certain configurations, no access door will be required.

The housing 140 should be configured to be inserted into a conventional tap 10 without modification. In other words, the housing 140 should be configured to be inserted between the handle 30 and the base 20 of a conventional tap 10. In a typical tap in the United States, the bolt 26 has a ⅜ inch diameter with 16 threads per inch (sometimes designated as ⅜-16), though different sizes and thread counts may apply in different parts of the world and in different applications. The housing 140 preferably includes a threaded recess 132 at its bottom portion that has essentially the same configuration as the threaded recess 32 at the bottom of the handle 30. Consequently, after removing the handle 30 from the base 20, the threaded recess 132 of the housing 140 can be threaded onto the threaded bolt 26 located at a top portion of the base 20. Similarly, the housing 140 also preferably includes a threaded bolt 126 located at its top portion that has essentially the same configuration as the standard bolt 26 at the top of the base 20. As a result, the original handle 30, after being removed from bolt 26 of the base 20, can be connected to the bolt 126 of the housing 140 (see FIG. 2).

Care must be taken when installing the housing 140 to ensure that the output mechanism 170 (e.g., a speaker) is pointing in the correct direction (e.g., toward the customers) when the threaded recess 132 is fully threaded onto the threaded bolt 26. This radial orientation of the device 110 can be significant for effective delivery of advertising or other messages to customers. Because the threading of the bolt 26 is not always precise, after fully threading the housing 140 onto the bolt 26, the output mechanism 170 may be in an undesirable location, such as directed toward the bartender. Many standard taps include a lock nut (not shown) at the base of the bolt 26. This lock nut can be adjusted upwards or downwards along the bolt 26 to ensure that the housing 140 stops in the proper orientation. Alternatively, a washer (or washers) of rubber or metal composition could be provided on the bolt 26 to allow the installer to adjust the final rotation of the housing 140 to the proper orientation.

In this preferred embodiment, the construction of the housing 140 allows the device 110 to be implemented without having to replace the existing base 20 or handle 30. By inserting the device 110 between the threaded bolt 126 at the top of the base 20 and the corresponding threaded recess 132 of the handle 30, the device 110 can be easily installed between the base 20 and the handle 30 of most standard beer taps and becomes an integral part of a standard beer tap assembly. Thus, information can be delivered to customers and/or recorded within the device at the point of sale in a cost-effective manner while continuing to use existing bases and decorative handles. Moreover, the housing 140 can be quickly and easily installed by a layperson using existing standard tap equipment.

The device 110 is preferably self-contained, i.e., it does not require an external power source. The power source 150 can be provided within the housing 140. Preferably the power source 150 is a battery. Even more preferably, the power source 150 is replaceable standard AA or AAA batteries. The use of replaceable batteries allows the user to easily maintain the power supply for the device 110 through battery replacement at the point of sale. The type of battery, however, is not essential to the invention. The battery could be rechargeable or expected to last for the anticipated life of the device 110. Other power sources could be used.

The device 110 includes a tap activation detector 160, which allows the device 110 to detect a change in position of the base 20, prompting the advertising message to be delivered and/or the pour to be recorded. For example, when the base 20 is moved into the flow position, the device 110 will detect the motion or change in position. The tap activation detector 160 could also be configured to recognize a return to the standby position.

The tap activation detector 160 could be configured to detect a change in position of the base 20 in a number of ways. The precise technology utilized by the device 110 to detect the change is not essential. Examples include the use of a multi-axis motion sensor or a mercury switch.

Preferably the tap activation detector 160 will accommodate the variability of base-line tilt of the base 20 of taps 10 in the market. In particular, some taps 10 are configured such that the base 20 is tilted even in the standby position. A multi-axis motion detector would be able to accommodate this variability without adjustment, i.e., it will be effective regardless of the base-line tilt of the tap 10. One example of such a motion detector can be found in U.S. Pat. No. 7,096,617, which is incorporated herein by reference in its entirety. Mercury switches, however, may require adjustment in the field to account for the base-line tilt of the base 20.

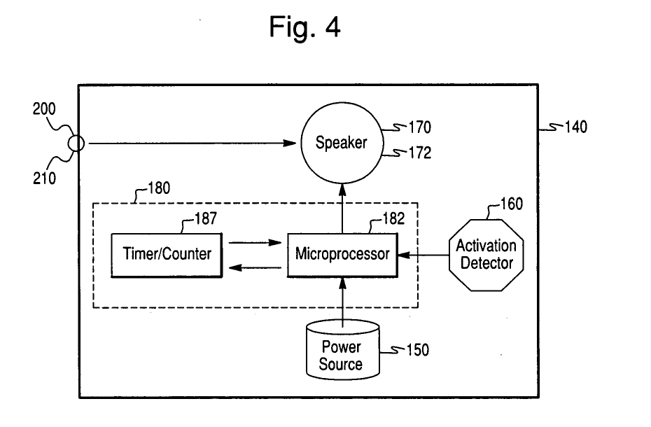

The device 110 could include at least one an information output device or output mechanism 170 for delivering information, as shown in FIGS. 1 and 4. Preferably the output mechanism 170 is a conventional speaker 172. The particular configuration of the speaker 172 is not critical to operation of the invention. It is preferred, however, that the speaker 172 minimize drain on the power source 150 while being sufficiently audible. Additionally, the speaker 172 preferably is liquid sealed and measures approximately 1.5 inches in diameter. More than one speaker 172 could be provided.

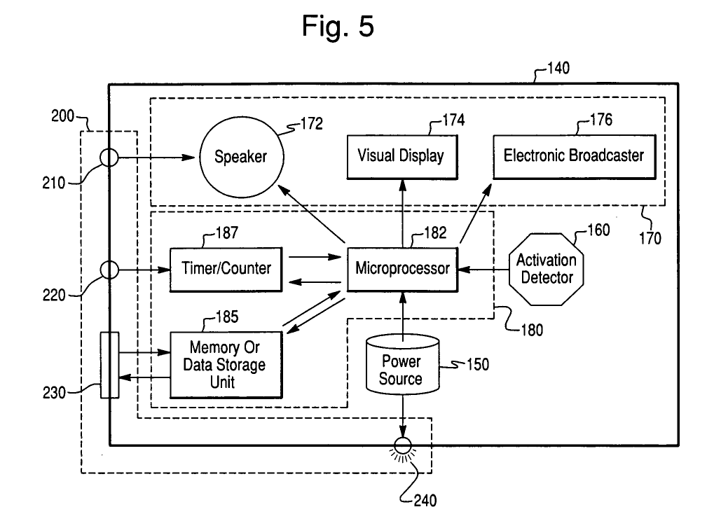

FIG. 5 is a block diagram of an alternative embodiment of the device 110, which has additional output mechanisms 170.

For example, in this embodiment, the device 110 includes an output mechanism 170 that provides visual information. In particular, a visual display 174 in the form of, for example, a translucent logo of the user's brand or other words or graphics could be embedded in the housing 140 of the device 110, and it could be backlit by a LED, incandescent bulb, or other illumination source. The lit-up logo 174 could attract attention when the device 110 is activated. The logo 174 could be illuminated in concert with the delivery of the audio advertising message, drawing attention to the logo and reinforcing customer recognition of the user of the device.

As a further example, in this embodiment, the device 110 includes an output mechanism 170, such as an electronic broadcaster 176, that provides electronic information. The electronic broadcaster 176 can be a conventional device designed to communicate with wireless devices in the vicinity of the tap. For example, the electronic broadcaster 176 could send promotional, public service, or other messages to consumer electronic devices, such as cell phones, e-mail devices, web browsers, wireless televisions, laptop computers, organizers, and pagers.

The device 110 also includes control circuitry 180, see FIGS. 4 and 5, which is provided to drive the output mechanism(s) 170 to deliver the information. The control circuitry could also drive the data recording functions of the device.

The control circuitry 180 could include, for example, a microprocessor or microchip 182 that will control the output mechanism(s) 170 to deliver information. For example, the microprocessor 182 could be pre-burned to contain an audio message (or messages) to be delivered through the speaker 172. The message could be a short pre-recorded advertising or other message (or messages). The microprocessor 182 may also govern and coordinate the operation of the device's 110 other electronic components, including visual displays.

The microprocessor 182 could be a permanent, pre-burned configuration that will deliver advertising messages for the life of the device 110. Alternatively, the microprocessor 182 could be replaceable in order to allow advertisers to update their messages. As another alternative, the microprocessor could be alterable to allow for customization of the messages. Specific advertising messages could be loaded and saved on the microprocessor, thereby allowing a custom message (or messages) to be delivered at the point of sale.

The control circuitry may also include a timer and/or counter 187. The timer/counter could be an integrated part of the microprocessor 182 or could be a separate element. The timer/counter 187 can allow a user to set the frequency of the delivery of advertising messages for optimum effectiveness. As an example, the microprocessor 182 may be configured to command the broadcasting of the information only after a predetermined number of tap activations have occurred, e.g., every tenth time. The number of tap activations will be counted by the timer/counter 187. As yet another example, the microprocessor 182 may be configured to limit the broadcasting of information so that a message is not repeated within a certain time period, such as five minutes, tracked by the timer/counter 187. Thus, the timer/counter 187 will not allow advertising messages to be delivered until after the completion of a pre-set resting period. This could prevent, for example, repeated message delivery when beers are topped off and avoid an over saturation of marketing messages within the tavern environment.

The control circuitry may also include a time structure (e.g., a clock and/or calendar feature) that could be, for example, embedded in the microprocessor 182 or configured as a separate element of the control circuitry (not shown). This time structure could be used for at least one of creating data regarding activations of the liquid dispensing assembly and using that information to govern the transmission of information. Thus, it could allow the device to deliver messages only at designated times and/or on designated dates. This would allow messages to be coordinated with media broadcasts, holidays, or promotional events, for example.

The device could be programmed to deliver other types of information unrelated to the beer being delivered by the tap. One example would be using the device to deliver public service messages. Messages encouraging patrons not to drink and drive or to drink responsibly, for example, could be delivered by the device. The voices of celebrities could be utilized to maximize the effectiveness of these public service announcements. These public service messages could be coordinated with the last hour before closing of the bar, for example, by utilizing the device's clock/calendar feature. Other non-beer related messages that could be delivered by the device might include information related to promotional offers within a restaurant or highlighted features within a theme park or sports stadium, for example. In addition, the device could be used by advertisers or media networks to promote product lines or broadcast events. For example, the device might deliver a message relating to a specific sporting event or team during the broadcast of that team's game, again utilizing the clock/calendar feature of the device. Alternatively, unrelated products or services could be promoted by the auditory and/or visual outputs of the device. The examples given above are meant to be illustrative and are not meant to address all potential uses of the device.

Additional features that could be incorporated into the device 110 include a contest structure, which causes the device 110 to cause transmission of information announcing a contest winner after at least one of a predetermined number of activations of the liquid dispensing assembly and a random number of activations of the liquid dispensing assembly (e.g., pours). Such a feature could be embodied, for example, by including in the control circuitry a number generator (predetermined or random) that could be, for example, embedded in the microprocessor 182 or configured as a separate element of the control circuitry (not shown). This contest structure could cause information to be output indicating a winner of the contest, e.g., the winner being the person whose numbered pour corresponds to the number generated by the number generator. This function could be used in concert with promotional events or marketing campaigns. Winners of the contest could receive a free beer or other prize.

The alternative embodiment of the device 110 shown in FIG. 5 includes a memory or data storage unit 185 in the control circuitry 180. The data storage unit 185 can store one or more pre-recorded messages that can be played upon command from the microchip. The data storage unit 185 can provide a programmable memory, which allows a user to update the audio and/or visual messages delivered by the device 110. Programmable memory would also allow users to update the timing of message delivery and adjust other functions governed by the control circuitry of the device. A conventional flash memory storage unit or other memory storage technology could be used to accomplish this function, accessed via the jack described below. Data could also be transmitted in and out of the device's memory storage via wireless technology. In other words, the device could include a transmitter and a receiver for the purpose of transmitting and receiving data.

The data storage unit 185 could also be used to record each pour of the tap, utilizing, for example the time structure (e.g., a clock and/or calendar capability embedded in the microprocessor 182). Alternatively, this time structure could be configured as a separate element of the control circuitry (not shown). The time and date of the start and finish of each pour, as indicated by the tap activation detector and time structure, could be recorded, creating a complete record of the tap's activity. Alternatively, a timer could be used in concert with the tap activation detector and time structure to record the time, date, and duration of each pour. In yet another configuration, each pour could be recorded only in the event that it exceeds a pre-determined threshold duration, for example, two seconds. This would prevent the recording of short “topping off” pours. In any case, the stored data of the tap's pouring activity could be extracted periodically and used for market research, consulting, and other purposes by the user of the device 110.

Extracted data would describe consumption behavior at the tap, indicating the relative volume of pours on weekdays versus weekends, or afternoons versus nights, for example. Beer companies can currently measure how many kegs of their product each bar is consuming, but they don't have information on what time of day or what day of the week the consumption occurs. The present device provides this high-resolution information.

Consumption data recorded by the device could be cross-referenced with demographic data to give insight into when various types of communities are consuming the product. This information regarding the timing of consumption as it relates to various demographic categories such as income, race, sex, age, and marital status could be used to coordinate advertising placement and promotional events in various markets.

Targeted advertisement placement, whether utilizing demographic data or not, could be very specific as a result of the data provided by the device. For example, if the data collected by the device reveals an increase in beer consumption during a specific sporting event in a specific market, advertisements could be purchased for future broadcasts of that event in that market.

In addition to guiding advertisement placement, the data collected from the device could be used to measure the effectiveness of specific advertising campaigns. Once a baseline data set is established, changes in relative consumption could be measured to a high level of precision. If a beer company runs a new advertisement in a specific market during a specific time, for example, they could use the data provided by the device to ascertain if there is an increase or decrease in consumption after the advertisement runs. This could be compared to a market where no advertisement or a different advertisement has been broadcast.

Devices could be installed on multiple, many, or even all taps within a given tavern. Taken together, these devices would present a detailed record of the consumption behavior within this tavern. This detailed market data could be used by beer companies, advertisers, market research firms, or consultants, for example, to measure the timing and volume of consumption of various brands or products. This data could then be analyzed to provide insight into the relative popularity of products, the effectiveness of advertising, changes in consumption behavior, and other uses. Various analytical techniques, including statistical sampling, could be used to enhance the usefulness of the collected data. This data and/or analysis could then be sold to one or more interested parties, including beer companies, advertisers, consultants, and research firms, for example, creating a new profit center for the user of the device. Devices could be deployed in multiple taverns, providing a detailed record of consumption patterns in regional markets or tavern types (for example, “sports bars”, “neighborhood bars” or “family restaurants”). In a final example, devices could be installed nationwide or worldwide to provide a comprehensive record of national or global draft beer consumption.

Individual devices could be distinguished from one another to help the users of the devices to keep track of which data is being generated by which tap in which location. Possible distinguishing technologies might include a distinct bar code on each device or a distinct electronic signature that could be contained within the data itself, conveyed by the microprocessor upon downloading, or broadcast wirelessly from each device. The specific technology of distinguishing the devices (and their data) from one another is not essential to the invention.

While examples given above may illustrate the utility and value of data collected by the device, they are not meant to describe every potential application of the data. Users of the device may discover other applications for the information collected by the device.

A conceptually distinct use of the data recorded by the device would be to compare the pouring history of a given tap with the transactional activities of the bartenders in that bar. Specifically, the recorded pours stored in the device could be cross-referenced with the beverage items charged by the bartenders, allowing non-charges (“comps”) and over-pours to be detected. Most bars now use computerized systems to record beverage sales, so the device would allow precise identification of pours that were not charged, including the time and date of the event. While the user of the device may not be concerned with non-charges or over-pours, bar owners would likely be interested in obtaining this information in order to rectify improper or unauthorized bartender behavior. If a beer company, advertiser, or consultant is indeed the user of the device, they could sell the device's recorded data back to bar owners, creating a new profit center for the beer company. Alternatively, access to this data could be used as an incentive to encourage bar owners to allow the placement of devices within their tavern by the user of the device. Alternatively, bar owners could be the ultimate user of the device, for the purpose of monitoring bartender activity.

While the preferred embodiment of the device includes both an audio and/or visual delivery function and a data collection function, the device might provide one or the other of these functions alone. In other words, the device could be configured to provide only message delivery functions without data collection, or to provide only data collection without message delivery.

The device 110 preferably includes user interaction controls 200. In the embodiment shown in FIG. 4, the user interaction controls 200 include a volume control 210 that allows a user to adjust the volume of the messages being delivered by the speaker 172. This could be accomplished with an adjustable volume control located inside the housing 140 of the device 110, accessed via a small hole and adjusted with a hex-wrench or screwdriver. This type of configuration would preserve the aesthetic integrity of the device 110, prevent accidental or unauthorized volume adjustment, minimize fluid invasion of the device 110, and allow operators of the device 110 to adjust volume levels appropriately while the device 110 remains installed. Alternatively, a liquid-sealed dial could be utilized.

When the volume control is turned all the way down, it could turn the device 110 off, preserving battery life when the unit is not in use. Alternatively, an independent on/off switch (not shown) could be included as part of the device 110.

The embodiment shown in FIG. 5 includes additional user interaction controls 200. For example, an adjustment knob 220 can be provided for the timer/counter 187. This adjustment knob could allow the frequency of message delivery (based, for example on the number of tap activations or the passage of time) to be adjusted at the point of sale. This would allow operators of the device 110 to tailor the frequency of message delivery to the tavern environment.

Another user interaction control 200 shown in FIG. 5 is an input/output jack 230, which can be provided to input data into or extract data from the device 110. For example, the input/output jack 230 can be used to re-program the device 110 with fresh marketing, public service, or informational messages. This would allow a beer company, for example, to program the device 110 to deliver marketing messages that would reinforce advertising campaigns as they present in other media such as television, radio, and printed advertisements. The value of the device 110 will be amplified significantly if consumers are reminded of the marketing campaigns they have viewed previously in other media when they hear the reinforcing audio messages delivered by the device 110. The input/output jack 230 could also be used to capture data collected by the device 110 regarding the time, date, and duration of tap activations.

The input/output jack 230 preferably is compatible with prevailing input/output technologies. For example, a USB or ETHERNET port might be appropriate, but other technologies could be used. The input/output jack 230 preferably is compatible with standard laptop computers or other typical data storage devices, including the devices typically used by beer distribution employees to record order and delivery information. These external data storage devices could be used to transport and then upload fresh advertising content into the beer tap device contemplated here and/or store the beer tap device's pour history after it has been downloaded via the input/output jack. The input/output jack 230 preferably is liquid-sealed with an attached sealing cap.

Wireless technology could be used as an alternative to achieve the same function as the input/output jack. An electronic broadcaster 176 could allow data stored within the beer tap device to be downloaded wirelessly into an external device. Examples of such external devices could include laptop computers, other typical data storage devices, or the devices typically used by beer distribution representatives to record order and delivery information. The electronic broadcaster could also include a receiving function, allowing the wireless uploading of new marketing messages from an external device into the beer tap device.

Yet another user interaction control 200 shown in FIG. 5 is low-power indicator light 240. The low-power indicator light 240 could be used to indicate when the power held by the devices' batteries falls below a certain level. This low-power indicator light 240 could allow the user to replace batteries proactively. The low-power indicator light 240 may be an LED embedded in the housing 140 of the device 110. Alternatively, a series of LEDs or an embedded gauge could be used to indicate a range of levels of remaining battery power.

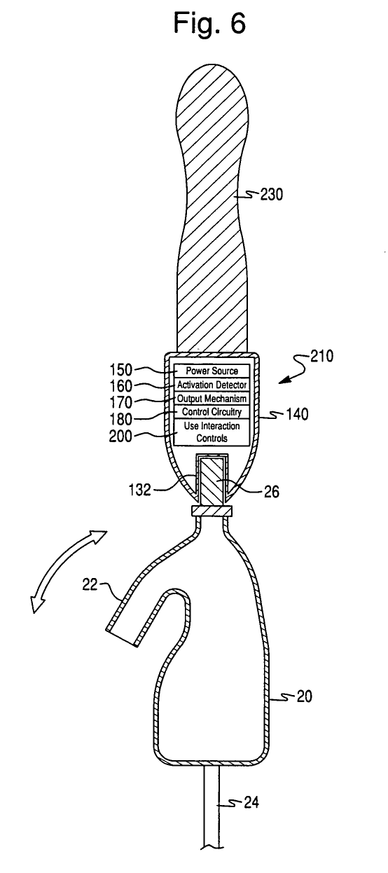

Though it is preferred that the device be configured to fit between a conventional handle 30 and base 20, it could be constructed in a less preferred embodiment in which the handle 30 is removed from the base 20 and replaced. In this embodiment, which is shown in FIG. 6, the device 210 includes its own handle 230 that is fixed to the housing 140 by conventional means (such as glue) or could be an integral part of the housing 140. This device 210 can include the functions and internal components (150, 160, 170, 180, and 200) of the device 110, as described above. While this alternative device 210 would not allow the flexibility or cost effectiveness of the device 110, it provides the ability to have a more seamlessly integrated visual appearance, with no distinct boundary between the handle 230 and the housing 140. In use, the original handle 30 will be removed from the base 20 and stored or discarded. The device 210, including both base 140 and affixed handle 230, would then be threaded onto the bolt 26 of base 20.

Thus, according to embodiments of the present invention, a device for a conventional tap is provided. Other embodiments of the invention will be apparent to those skilled in the art from consideration of the specification and practice of the invention disclosed herein. It is intended that the specification and examples be considered as exemplary only.

What is claimed:

1. An information device configured to be incorporated into a liquid dispensing assembly including a base with a threaded portion and a handle with a threaded portion operatively connected to the threaded portion of the base, the information device comprising:
a housing having a lower portion configured to mate with the threaded portion of the base and an upper portion configured to mate with the threaded portion of the handle;
a detector configured to detect activation of the liquid dispensing assembly; and
control circuitry configured to cause at least one of transmission of information and recording of data in response to detected activation of the liquid dispensing assembly; and
wherein the information device is configured to be placed between the base and handle of the conventional liquid dispensing assembly.

2. The information device of claim 1, wherein the housing is configured to be at least one of liquid resistant and liquid proof.

3. The information device of claim 1, further comprising a power source located within the housing for powering the control circuitry.

4. The information device of claim 1, wherein the control circuitry is configured to at least one of:
(a) cause the transmission of at least one of an audio, visual, and electronic message in response to detected activation of the liquid dispensing system; and
(b) record data related to detected activation of the liquid dispensing system.

5. The information device of claim 1, further comprising user interaction controls including at least one of:
(a) a volume control;
(b) an adjustment knob configured to adjust the frequency of information transmission;
(c) an input/output jack configured to at least one of upload messages to the control circuitry, upload data to the control circuitry, and download data from the control circuitry;
(d) a wireless broadcaster configured to at least one of upload messages to the control circuitry, upload data to the control circuitry, and download data from the control circuitry; and
(e) a low-power indicator light.

6. The information device of claim 1, wherein said device is integrally formed in or fixed to the handle of the conventional liquid dispensing system.

7. The information device of claim 1, further comprising an identifier configured to distinguish the information device from other information devices.

8. The information device of claim 1, further comprising an information output device for transmitting information.

9. The information device of claim 8, wherein the information output device includes an audio speaker.

10. The information device of claim 8, wherein the information output device includes a visual display.

11. The information device of claim 8, wherein the information output device includes an electronic broadcaster configured to wirelessly transmit messages to devices capable of receiving wireless transmissions.

12. The information device of claim 1, wherein the control circuitry includes at least one of:
(a) a timer for tracking the amount of time between transmissions of information;
(b) a counter for counting activations of the liquid dispensing assembly;
(c) a time structure for at least one of creating data regarding activations of the liquid dispensing assembly and governing the transmission of information; and
(d) a contest structure for causing transmission of information announcing a contest winner after at least one of a predetermined number of activations of the liquid dispensing assembly and a random number of activations of the liquid dispensing assembly.

13. The information device of claim 1, further comprising a data storage device configured to at least one of:
(a) store information for transmission in response to detected activation of the liquid dispensing assembly; and
(b) record data in response to detected activation of the liquid dispensing assembly.

14. A data collection device configured to be incorporated into a tap, the data collection device comprising:
a housing;
a detector configured to detect activation of the liquid dispensing assembly;
control circuitry configured to cause recording of data in response to detected activation of the liquid dispensing assembly; and
a data storage device configured to record data in response to detected activation of the liquid dispensing assembly.

15. The data collection device of claim 14, wherein the control circuitry is configured to store information in the data storage related to each activation of the tap, wherein the information includes at least one of the time, date, and duration of the activation.

16. The data collection device of claim 14, wherein the tap includes a base with a threaded portion and a handle with a threaded portion operatively connected to the threaded portion of the base, and the housing includes a lower portion configured to mate with the threaded portion of the base and an upper portion configured to mate with the threaded portion of the handle.

17. The data collection device of claim 14, further comprising a power source located within the housing for powering the control circuitry.

18. The data collection device of claim 14, further comprising an identifier configured to distinguish the data collection device from other data collection devices.

19. The data collection device of claim 14, further comprising an information output device for transmitting information.

20. The data collection device of claim 19, wherein the information output device includes an electronic broadcaster configured to wirelessly transmit messages to devices capable of receiving wireless transmissions.

21. The data collection device of claim 14, further comprising user interaction controls including at least one of:
(a) an input/output jack configured to at least one of upload data to the control circuitry and download data from the control circuitry; and
(b) a wireless broadcaster configured to at least one of upload data to the control circuitry and download data from the control circuitry.
